(19) United States
(12) Patent Application Publication
(10) Pub. No.: US 2024/0109269 A1
(43) Pub. Date: Apr. 4, 2024

(54) Detachable Guard for Industrial Press

(71) Applicant: Robert Bosch GmbH, Stuttgart (DE)

(72) Inventors: Robert Kochie, Dodge City, MI (US); Marcelo Alves de Moraes, Apple Valley, MN (US)

(21) Appl. No.: 17/955,828

(22) Filed: Sep. 29, 2022

(51) Int. Cl. B30B 15/08; F16P 3/08

(52) U.S. Cl. CPC B30B 15/08; F16P 3/08

(57) ABSTRACT

A press guard configured to be detachably coupled to an industrial press machine. The press guard comprises a guard surface that is not flush with the work surface of the industrial press, providing a gap-space to accommodate work pieces of irregular size or shape. The press guard further comprises a hinge bracket and latch mechanism to detachably couple to industrial presses having a wide variety of configurations.

### TECHNICAL FIELD

This disclosure relates to aftermarket safety features for industrial press equipment.

### BACKGROUND

Industrial press operations are vital for the manufacture of goods. Presses apply pressure forces to work pieces to be used in the assembly of manufactured goods. However, industrial presses exert such large forces upon the work pieces that it is common for materials of the work piece to be expelled from the workpiece during application of pressure. Such materials may be expelled as swarf, splinters, dust, or other materials deformed or broken during the press process. The expulsion of these materials represents a potential safety hazard to users of the industrial press.

Conventional safety precautions for industrial presses may utilize a press guard that may be attached to the industrial press. However, conventional press guards are limited in that they will typically sit flush with the work surface of the press, minimizing the ability to utilize the press guard with a wide variety of work pieces, including work pieces having irregular shapes or sizes. Additionally, contemporary press guards are often designed to be used only with a specific press in a particular configuration. What is desired is a press guard that may be compatible with a large variety of presses, and may provide a safe operation of the press under a wide variety of configurations and with a wide variety of irregular or over-sized work pieces.

### SUMMARY

One aspect of this disclosure is directed to a press guard configured to be attached to an industrial press, the press guard comprising a first brace member, a second brace member opposite the first brace member, and a guard surface extending in a first direction from the first brace member to the second brace member. The press guard further comprises a hinge bracket coupled to the first brace member, the hinge bracket comprising a flange having a number of holes. The press guard further comprises a latch coupled to the second brace member, the latch configurable using a rotational handle. The hinge bracket is configured to detachably couple to an upright of the industrial press utilizing a pin configured to fit one of the number of holes. The press guard is affixed to the upright using the pin during the detachable coupling. A portion of the guard surface extends in a second direction different from the first direction. In some embodiments, the guard surface extends radially, and in some embodiments the guard surface extends at an angle formed by panels.

The above aspects of this disclosure and other aspects will be explained in greater detail below with reference to the attached drawings.

### BRIEF DESCRIPTION OF THE DRAWINGS

FIG. 1 is an illustration of an industrial press.

FIG. 2 is an illustration of an industrial press coupled with a detachable press guard.

FIG. 3 is an illustration of the industrial press and press guard of FIG. 2, displayed from a different viewpoint to show additional features of the press guard.

FIG. 4 is an illustration of a press guard.

FIG. 5 is an illustration of the press guard of FIG. 4, displayed at an alternate angle to show additional features.

FIG. 6 is a close-up illustration of a hinge bracket of a press guard when coupled to an industrial press.

FIG. 7 is a close-up and partially disassembled illustration of the hinge bracket of FIG. 4.

FIG. 8 is a close-up illustration of a latch of a press guard when coupled to an industrial press.

FIG. 9 is an illustration of a press guard comprising an angularly extended guard surface.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

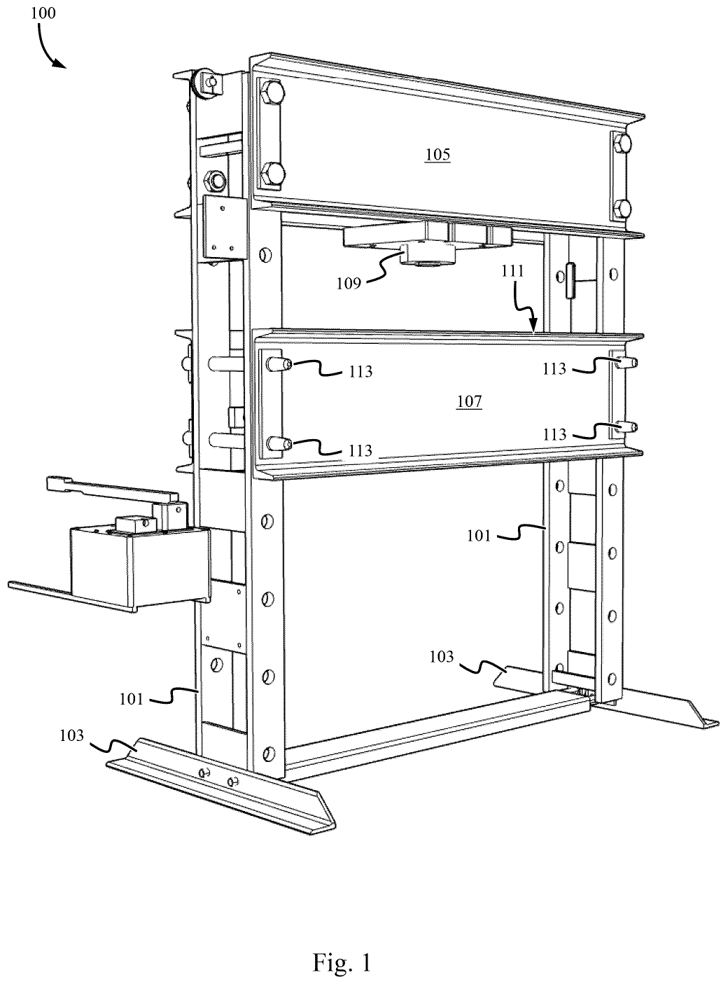

FIG. 1 is an illustration of an industrial press 100, comprising a pair of uprights 101, each supported by a foot 103. Press 100 is additionally supported by an upper bolster 105 and a lower bolster 107. Upper bolster 105 provides support for the extension and application of the press cylinder 109. Lower bolster 107 comprises a work surface 111 suitable to support a workpiece (not shown) to be subject to the press cylinder 109. To accommodate a variety of workpieces having different sizes, lower bolster 107 may be moved up and down with respect to the length of uprights 101, thus positioning work surface 111 at varying distances from hydraulic cylinder 109. This is accomplished by removing a number of bolster pins 113 that thread through designated pinholes in lower bolster 107 and uprights 101. When the bolster pins 113 are removed, lower bolster 107 may freely slide long the length of the uprights 101. The bolster pins 113 may be re-inserted to stabilize the position of lower bolster 107 after the lower bolster 107 has been re-positioned at a desired height with respect to industrial press 100.

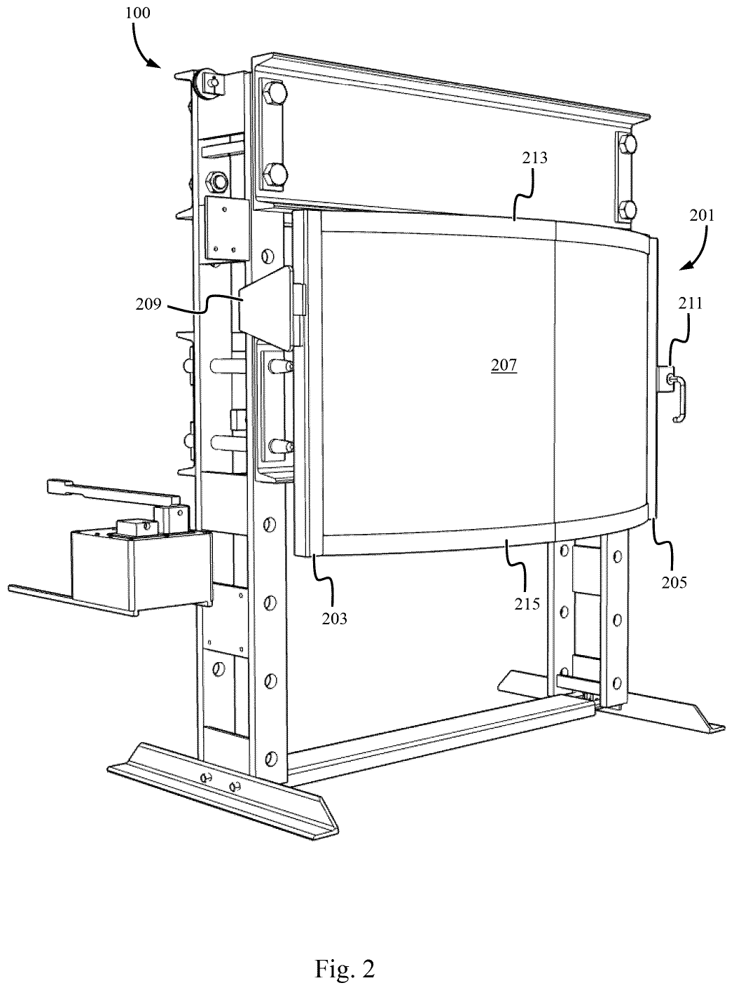

During utilization of industrial press 100, the workpiece is subjected to high pressure from press cylinder 109. In some embodiments, the industrial press may be capable of exerting pressures in excess of 100 tons. Under such conditions, the workpiece is expected to undergo deformation, but other byproducts of the press may include debris or swarf being expelled from the work surface 111. For this reason, a guard mechanism is desired to shield users from debris or swarf during operation of industrial press 100. FIG. 2 is a depiction of industrial press 100 while coupled with a press guard 201.

Press guard 201 is detachably coupled to industrial press 100, and is supported by a first brace member 203 and a second brace member 205. Spanning between first brace member 203 and second brace member 205 is a guard surface 207. Guard surface 207 provides shielding to users standing behind it during operation of industrial press 100. In the depicted embodiment, guard surface 207 comprises an expanded metal mesh, but other embodiments may comprise other configurations without deviating from the teachings disclosed herein. Such embodiments may utilize a guard surface comprised of sheet metal, ported sheet metal, wire mesh, acrylic polymer, polycarbonate polymer, or any other material or combination of materials known to one of ordinary skill in the art without deviating from the teachings disclosed herein. Embodiments of guard surface 207 that provide a line of sight to the work piece while in position and coupled to industrial press 100 advantageously provides protection to a user without impeding their ability to monitor the press operation.

Press guard 201 detachably couples to industrial press using a hinged bracket 209 and a latch 211. In the depicted embodiment, hinged bracket 209 is coupled to first brace member 203 and latch 211 is coupled to second brace member 205, but other embodiments may comprise other configurations without deviating from the teachings disclosed herein. In some embodiments, a press ward may comprise a plurality of hinge brackets 209 or latches 211 without deviating from the teachings disclosed herein. In some embodiments, a press guard may comprise only a plurality of hinge brackets 209 or a plurality of latches 211 to couple to industrial press 100 without deviating from the teachings disclosed herein. In the depicted embodiment, press guard 201 additionally comprises an upper cross brace 213 and lower cross brace 215 to provide additional support and structure to the shape and stability of guard surface 207. Other embodiments may comprise a different configuration not featuring, one or more of upper cross brace 213 or lower cross brace 215 without deviating from the teachings disclosed herein.

Press guard 201 detachably couples to industrial press 100, which advantageously permits a user to more easily place the workpiece and position lower bolster 107 (see FIG. 1) without press guard 201 impeding the setup of the industrial press in any way.

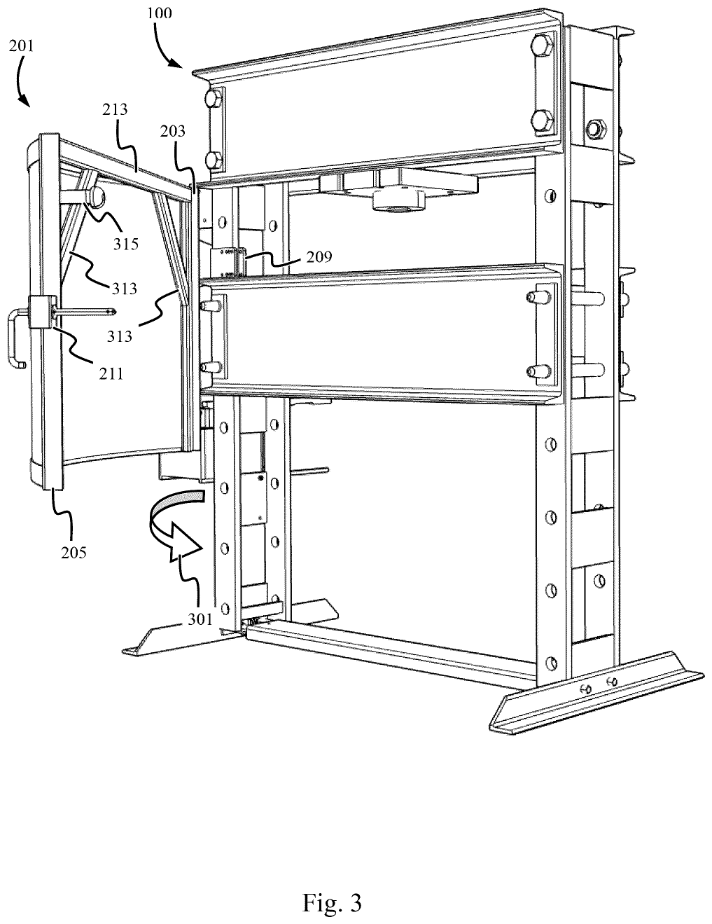

However, in some circumstances it may be more convenient for a user if the press guard 201 can be temporarily moved away from work surface 111 without decoupling entirely from industrial press 100. To accommodate for this, the hinged bracket 209 of press guard 201 permits a swinging motion to temporarily move press guard 201 away from work surface 111. FIG. 3 presents an alternative view of press guard 201 while coupled to industrial press 100 using only hinged bracket 209. Because hinged bracket 209 comprises a hinge, press guard 201 is able to rotate about an axis of the hinge, effectively providing motion in a rotational direction 301. In the depicted embodiment, hinged bracket 209 comprises greater than 180-degrees of rotational motion, but other embodiments may comprise different ranges of motion without deviating from the teachings disclosed herein.

FIG. 3 additionally provides an alternative view of press guard 201 and illustrates additional features thereof. In particular, press guard 201 comprises a number of diagonal braces 313 extending from the first brace member 203 and second brace member 205 to upper cross brace 213. Diagonal braces 313 provide additional structure and stability to guard surface 207, increasing the protection it provides to a user during a press operation. Some embodiments may additional diagonal braces 313, such as a pair extending to lower cross brace 215, without deviating from the teachings disclosed herein. Some embodiments may not have any diagonal braces without deviating from the teachings disclosed herein. Other embodiments may comprise a different number or arrangement of diagonal braces 313 without deviating from the teachings disclosed herein.

Press guard 201 also comprises a guardstop 315 extending from second brace member 205 in the direction of industrial press 100. Guardstop 315 provides a degree of protection to both press guard 201 and industrial press 100 during motion of press guard 201 about rotational direction 301 by acting a safeguard to minimize impact or collision of press guard 201 with industrial press 100. In the depicted embodiment, guardstop 315 comprises a polymer tip that can make impact with industrial press 100 without damaging any component of industrial press 100 or press guard 201. Other embodiments may comprise other configurations of guardstop 315 without deviating from the teachings disclosed herein. Other embodiments may comprise a different number or placement of guardstop 315 without deviating from the teachings disclosed herein. Some embodiments may not comprise a guardstop without deviating from the teachings disclosed herein. In the depicted embodiment, guardstop 315 provides an additional advantageous function in that the length of the guardstop 315 is chosen to optimize placement of latch 211 with respect to industrial press 100 during detachable coupling of the two. This length is advantageous because a user does not need to measure the distance between second brace member 205 and any component of industrial press 100 to ensure that latch 211 can be actuated successfully during coupling. Instead, a user can merely swing press guard 201 about rotational direction 301 until the guardstop 315 makes contact with industrial press 100, and the user will know that the latch 211 will be functional. Other embodiments may comprise other configurations without deviating from the teachings disclosed herein.

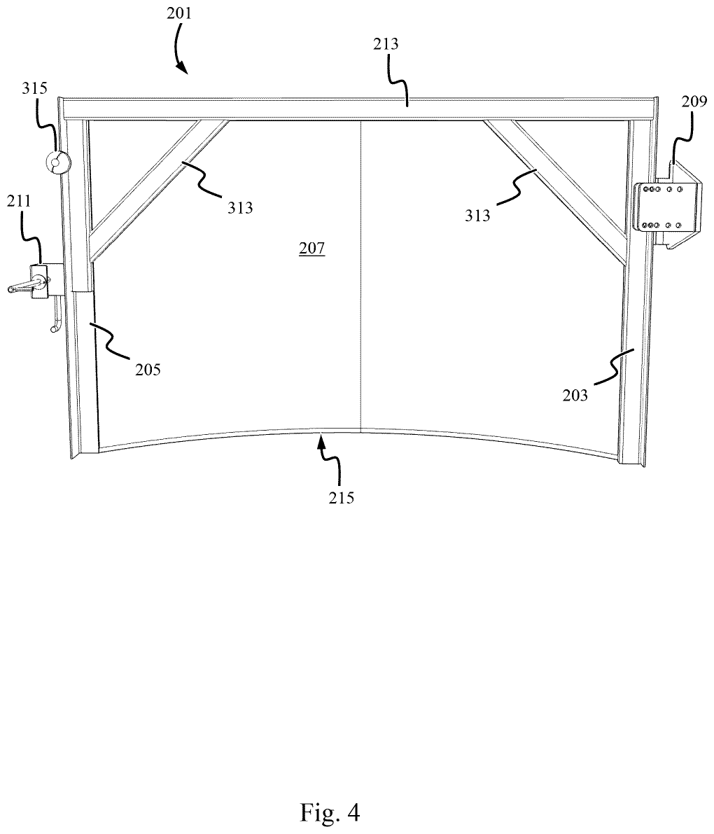

FIG. 4 provides an additional view of press guard 201, showing the components discussed above with respect to FIG. 3, except from an angle that does not include any elements of industrial press 100 (see FIG. 1, FIG. 2, FIG. 3). In this view, additional details of press guard 201 may be observed without obstruction.

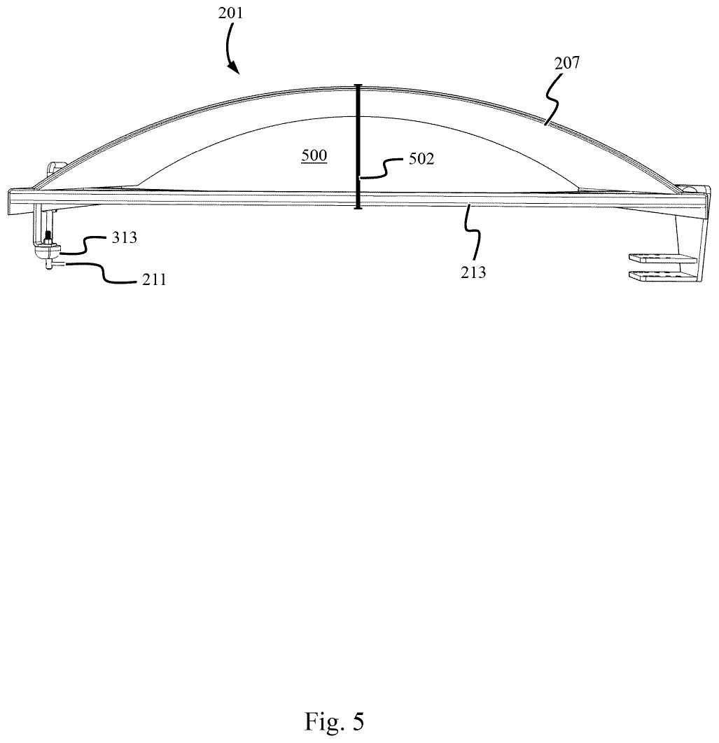

FIG. 5 provides an additional top-down isometric view of press guard 201. In this view, the configuration of guard surface 207 can be observed, and in particular a radial bend of the guard surface 207 is illustrated. This radial bend creates a gap-space 500 that is enclosed by the guard surface 207. Gap-space 500 advantageously permits a user of industrial press to safely operate on a larger variety of workpieces having different sizes and shapes compared to a configuration where guard surface 207 was flush with upper cross brace 213, the tip of guardstop 313, or any other element of press guard 201. Gap-space 500 can accommodate extension of parts of a workpiece away from work surface 111 (not shown; see FIG. 1) up to a distance of a curve radius 502 of guard surface 207. In the depicted embodiment, curve radius 502 may comprise a radius of 2 feet, but other embodiments may comprise different curve radii without deviating from the teachings disclosed herein. Because press guard 201 is detachable from the industrial press, a user may advantageously utilize different embodiments of press guard 201 having different curve radii 502 in order to optimize the utility and safety of the associated press operations of industrial press 100 (not shown, see FIG. 1) without deviating from the teachings disclosed herein.

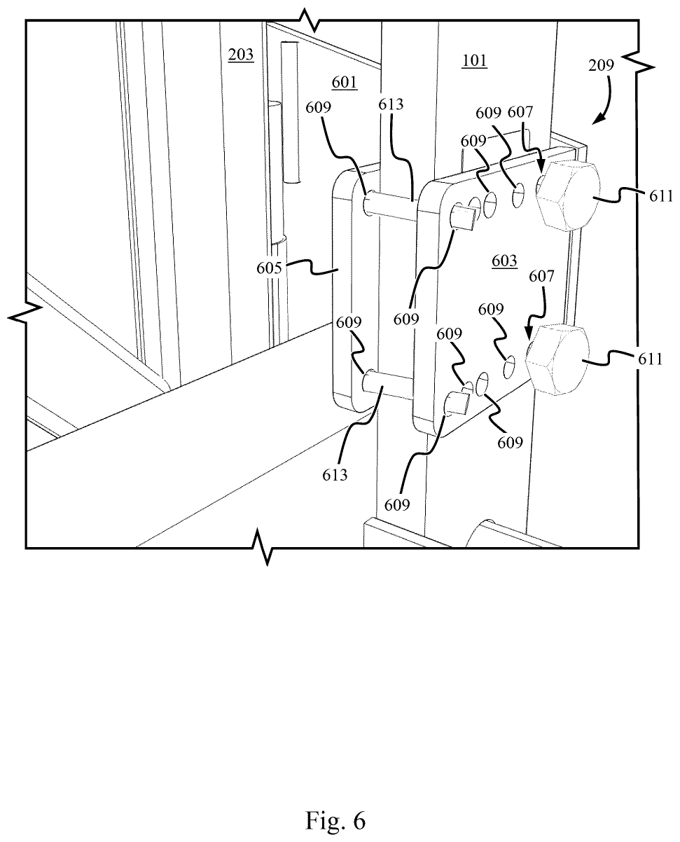

In the depicted embodiment, the coupling of press guard 201 to industrial press 100 utilizes both the hinge bracket 209 and latch 211. FIG. 6 is a close-up illustration of the hinge bracket 209 in situ while the press guard 201 (see FIG. 2, FIG. 4) is coupled to an upright 101 of industrial press 100 (see FIG. 1). Hinge bracket 209 comprises a bracket extension 601. Coupled to the distal end of bracket extension 601 are a first flange 603 and a second flange 605. First flange 603 and second flange 605 are configured to surround upright 101 snugly whilst press guard 201 is coupled to industrial press 100. Each of first flange 603 and second flange 605 comprise a number of holes, some of the holes in alignment with holes of the other flange. The holes are utilized to stabilize the coupling. Some of the holes are threaded holes 607, while others are unthreaded holes 609. The holes are configured to receive pins that stabilize the placement of press guard 201. Threaded holes 607 are configured to receive a threaded pin 611 having a screw thread that matches the threading of threaded holes 607.

In the depicted embodiment, threaded pin 611 comprises a pin having a hand knob to be rotated by hand, which advantageously permits a user to place the pins single-handedly and without requiring any specialized tools. In other embodiments, other configurations of threaded pin 611 may be utilized without deviating from the teachings disclosed herein. In this embodiment, the threaded holes 607 are positioned closest to bracket extension 601 to help stabilize the placement of hinge bracket 209 (and by extension, press guard 201). During coupling, a user will screw threaded pin 611 until the tip of the pin comes into contact with the surface of upright 101. The friction force exhibited between the threaded pin 611 and upright 101 is utilized to stabilize the placement of press guard 201. In the depicted embodiment, first flange 603 comprises a pair of threaded holes 607, but other embodiments may comprise other arrangements without deviating from the teachings disclosed herein. In some embodiments, threaded hole 607 is positioned in such a way that threaded pin 611 will not make contact with the proximal surface of upright 101, but will instead interface with a different surface or additional feature of upright 101. This configuration advantageously provides a greater degree of compatibility with a large degree of configurations for industrial press 100.

In the depicted embodiment, each of the flanges of hinge bracket 209 are configured with a number of unthreaded holes 609. Unthreaded holes 609 are configured to receive an unthreaded pin 613. Unthreaded pins 613 are utilized during the coupling of press guard 201 to industrial press 100 to restrict the rotational motion of hinge bracket 209, thus stabilizing the placement of press guard 201 during coupling. In the depicted embodiment, the unthreaded holes 609 are arranged on the flanges in such a way as to accommodate for different widths of an upright 101. This advantageously increases the versatility of press guard 201 by providing compatibility with a greater range of industrial press configurations. By way of example, and not limitation, the depicted arrangement of unthreaded holes 609 may correspond to common upright widths for industrial presses having a 1 ton, 25 ton, 55 ton, and 100 ton capacity, but other embodiments may comprise other arrangements without deviating from the teachings disclosed herein.

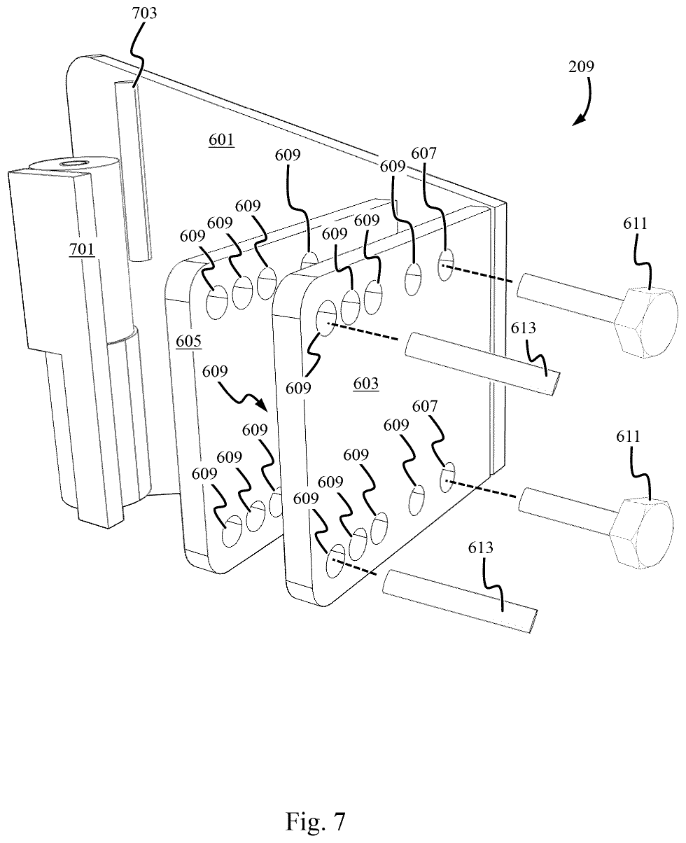

FIG. 7 provides an isolated view of hinge bracket 209 to present the features clearly without obstruction from other elements of press guard 201 (see FIG. 2, FIG. 4) or any element of industrial press 100 (see FIG. 1). In this depiction, threaded pins 611 and unthreaded pins 613 are aligned with some of the holes of first flange 603, but are not inserted. In the depicted embodiment, it is noted that second flange 605 does not comprise any threaded holes 607 because this embodiment is configured to utilize surface between threaded pins 611 and the contact surface of a press upright. As such, the upright would necessarily be blocking a corresponding hole of second flange 605. Some embodiments may still comprise aligned threaded holes, for the purpose of advantageously permitting a user to utilize the threaded pins 611 from the other side of the upright (i.e., inserted only from second flange 605) without deviating from the teachings disclosed herein. In the depicted embodiment, utilization of the threaded holes 607 of first flange 603 advantageously permits unimpeded access to the threaded holes 607 from the exterior, improving ease-of-use for the user inserting a threaded pin 611 by hand.

Also depicted in FIG. 7 are the hinge 701 and hinge stopper 703 of hinge bracket 209. Hinge 701 provides the rotational mechanism for press guard 201 described above with respect to FIG. 3. Hinge stopper 703 provides a limit to the range-of-motion of hinge 701, which can help to alleviate concerns about undesired extension or motion during rotation. Some embodiments may not comprise a hinge stopper 703 without deviating from the teachings disclosed herein.

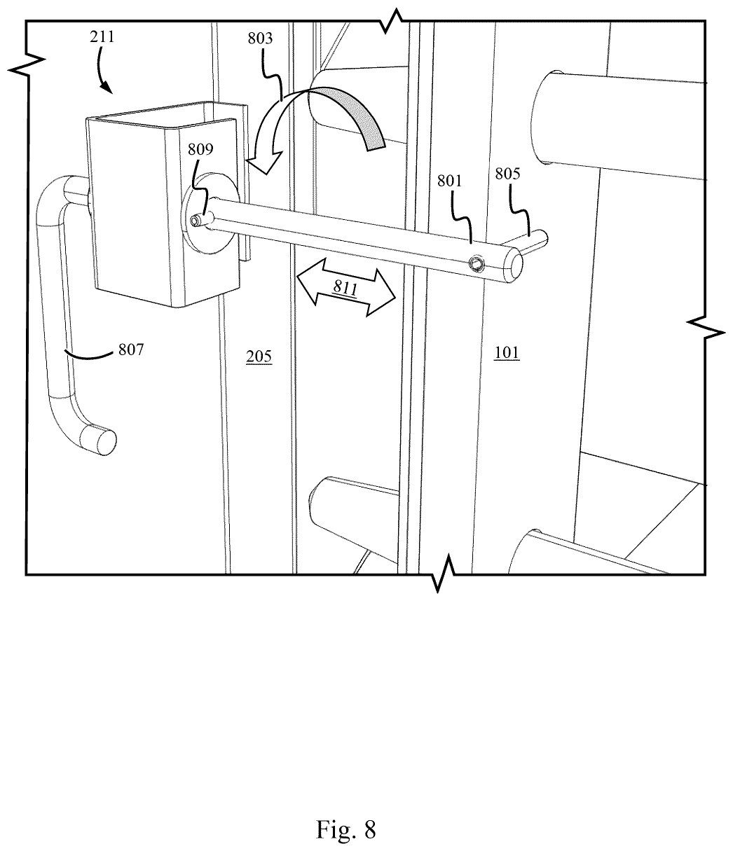

The other element of press guard 201 that holds it to the industrial press during coupling is latch 211. FIG. 8 depicts latch 211 in situ during coupling, interfacing with an upright 101 of an industrial press 100 (see FIG. 1). Latch 211 comprises a latch arm 801 that extends from the press guard and hooks around the upright 101 with a hooking member 803. The hooking motion is controlled by rotating the latch arm 801 about a rotational direction 805 during coupling of the press guard to the industrial press. A user may control the rotation of the latch arm 801 using a handle 807, but other embodiments may comprise other configurations without deviating from the teachings disclosed herein. The extension of the latch arm 801 advantageously may be configured to correspond to the distance of the second brace member 205 (to which latch 211 is coupled) from the distal surface of upright 101. This configuration advantageously permits a user to unlatch and relatch press guard 201 without having to adjust the extension of the latch arm 801 each time in order to ensure a secure fit. In the depicted embodiment, extension of latch arm 801 with respect to an extension direction 809 may be adjusted by the user in order to ensure a secure fit of the hooking member 803 around the distal surface of upright 101. This extension may be adjusted by the user in order to advantageously improve compatibility of the press guard with a variety of industrial press designs. In the depicted embodiment, latch 211 additionally comprises a lock pin 809 which may be actuated in order to restrict motion of the latch arm 801. In the depicted embodiment, lock pin 809 may restrict motion of the latch arm 801 with respect to both rotational direction 805 and extension direction 811, but other embodiments may only restrict one of the motions without deviating from the teachings disclosed herein. In some embodiment, latch 211 may not comprise a lock pin without deviating from the teachings disclosed herein.

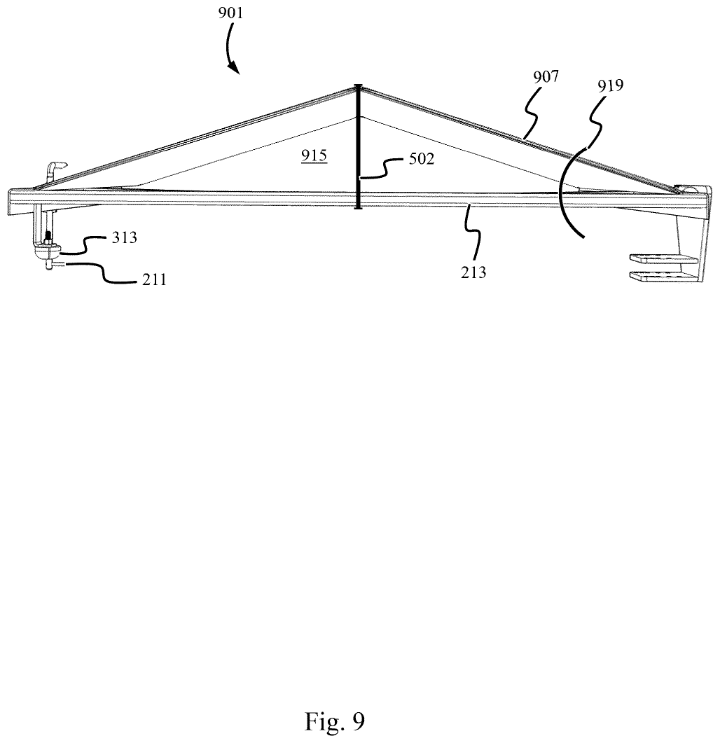

Other embodiments of a press guard may comprise additional arrangements or configurations. FIG. 9 provides an isometric overhead view of a press guard 901 that is identical to press guard 201 (see FIG. 5) except for the configuration of its respective guard surface 907. Whereas press guard 201 comprised a guard surface 207 exhibiting a radial extension, press guard 901 comprises a guard surface 907 exhibiting an angular extension. In other words, guard surface 907 is formed by a number of panels joined at an angle, rather than a single curved surface. In the depicted embodiment, guard surface 907 still exhibits a maximum displacement 502 matching that of guard surface 207, but because of the differing geometry the resulting gap-space 915 comprises a different volume than that of the gap-space 500 exhibited by press guard 200. In the depicted embodiment, the angle of extension 919 exhibited by guard surface 907 is approximately 19 degrees with respect to upper cross brace 213, but other embodiments may comprise other angles without deviating from the teachings disclosed herein. By way of example, and not limitation, a 10-degree tolerance may be exhibited in this angle without deviating from the teaching of this particular embodiment. Other embodiments may comprise a greater degree of variation in the extension 502 and angle of extension 919 without deviating from the teachings disclosed herein.

In the depicted embodiment, guard surface 907 comprises a single angle comprised of two panels forming a triangular enclosure with respect to upper cross brace 213, but other embodiments may comprise a different number of panels forming a different number of angles and exhibiting other shapes without deviating from the teachings disclosed herein. In the depicted embodiment, the maximum extension 502 of guard surface 907 is at a midpoint between either side of guard surface 907, but other embodiments may comprise other arrangements without deviating from the teachings disclosed herein. In some embodiments, multiple angles may be utilized at regular or irregular distance intervals along the length of guard surface 907 without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A press guard configured to be attached to an industrial press, the press guard comprising:
a first brace member;
a second brace member opposite the first brace member;
a guard surface extending in a first direction from the first brace member to the second brace member;
a hinge bracket coupled to the first brace member, the hinge bracket comprising a flange having a number of holes;
a pin configured to fit one of the number of holes;
a latch coupled to the second brace member, the latch configurable using a rotational handle, wherein
the hinge bracket is configured to detachably couple to an upright of the industrial press, the press guard is affixed to the upright using the pin during the detachable coupling, and wherein a portion of the guard surface extends in a second direction different from the first direction.

2. The press guard of claim 1, wherein the hinge bracket comprises a plurality of flanges, each of the flanges having the number of holes, wherein each of the holes of a flange is aligned with a corresponding hole of the others of the plurality of flanges.

3. The press guard of claim 2, wherein one of the number of holes for each of the flanges comprises a threaded hole, wherein the flanges are spaced to be positioned on either side of a an upright of the industrial press, wherein each of the number of holes other than the threaded hole are spaced at a distance away from their flange's respective threaded hole corresponding to a standardized width, and wherein the press guard further comprises a pin configured to be inserted into aligned holes of the flanges when the press guard is detachably coupled to the upright.

4. The press guard of claim 1, wherein the latch further comprises a locking mechanism configured to lock the position of the latch in place while the press guard is detachably coupled to the upright of the industrial press.

5. The press guard of claim 1, wherein the center point of the guard surface is maximally-extended in the second direction.

6. The press guard of claim 5, wherein the guard surface exhibits a radial curvature, the center point of the guard surface extending the maximum radius from a plane defined by the first brace member, the second brace member, and the first direction.

7. The press guard of claim 5, wherein the guard surface comprises a first panel coupled to the first brace member and a second panel coupled to the second brace member, the first panel and the second panel forming an angle.

8. The press guard of claim 7, wherein the angle formed is between 9 and 29 degrees.

9. The press guard of claim 1, wherein the guard surface is constructed with an expanded metal having a number of ports

10. The press guard of claim 1, wherein the guard surface is constructed with a polymer.

11. A press guard configured to be attached to an industrial press, the press guard comprising:
a first brace member;
a second brace member opposite the first brace member; and
a guard surface extending in a first direction from the first brace member to the second brace member, wherein
a portion of the guard surface extends in a second direction perpendicular to the first direction.

12. The press guard of claim 12, wherein the center point of the guard surface is maximally extended in the second direction.

13. The press guard of claim 12, wherein the guard surface comprises an angle.

14. The press guard of claim 11, wherein the guard surface exhibits a radial curvature, the center point of the guard surface extending the maximum radius from a plane defined by the first brace member, the second brace member, and the first direction.

15. The press guard of claim 11, wherein the guard surface comprises a first panel coupled to the first brace member and a second panel coupled to the second brace member, the first panel and the second panel forming an angle.

16. The press guard of claim 15, wherein the angle formed is between 9 and 29 degrees.

17. A press guard configured to be attached to an industrial press, the press guard comprising:
a first brace member;
a second brace member opposite the first brace member;
a guard surface extending in a first direction from the first brace member to the second brace member;
a hinge bracket coupled to the first brace member, the hinge bracket comprising a flange having a number of holes wherein at least one of the number of holes is a threaded hole;
a pin configured to fit the threaded hole, the pin comprising a knob;
a latch coupled to the second brace member, the latch configurable using a rotational handle, wherein
the hinge bracket is configured to detachably couple to an upright of the industrial press, and wherein the press guard is affixed to the upright using the pin during the detachable coupling.

18. The press guard of claim 17, wherein the hinge bracket comprises a plurality of flanges, each of the flanges having the number of holes, wherein each of the holes of a flange is aligned a corresponding hole of the others of the plurality of flanges.

19. The press guard of claim 18, wherein the flanges are spaced to be positioned on either side of a an upright of the industrial press, wherein each of the number of holes other than the threaded hole are spaced from their flange's respective threaded hole at a distance away corresponding to a standardized width, and wherein the press guard further comprises a pin configured to be inserted into aligned holes of the flanges when the press guard is detachably coupled to the upright.

20. The press guard of claim 17, wherein the latch further comprises a locking mechanism configured to lock the position of the latch in place while the press guard is detachably coupled to the upright of the industrial press.
